(19) United States
(12) Patent Application Publication
(10) Pub. No.: US 2024/0393655 A1
(43) Pub. Date: Nov. 28, 2024

(54) INTEGRATED OPTICAL COUPLING SWITCH

(71) Applicant: SHENZHEN LIGHTING INSTITUTE, Shenzhen (CN)

(72) Inventor: Andrew LIN, Shenzhen (CN)

(21) Appl. No.: 18/796,115

(22) Filed: Aug. 6, 2024

Related U.S. Application Data
(63) Continuation of application No. PCT/CN2023/078056, filed on Feb. 24, 2023.

(30) Foreign Application Priority Data
Apr. 12, 2022 (CN) 202210383343.5

(51) Int. Cl. G02F 1/225; G02F 1/21

(52) U.S. Cl. CPC G02F 1/225; G02F 1/212

(57) ABSTRACT

An integrated optical coupling switch, including two parallel optical waveguides, two electrostatically attracted electrodes and an insulating layer. The electrodes includes a lower electrode that is arranged on a silicon surface and avoids the optical waveguides, and an upper electrode that is arranged above the optical waveguides and formed as a micro-electromechanical architecture, and the upper electrode is attracted to come into contact with a surface of the optical waveguide when reaching a preset voltage value; the insulating layer is arranged on a surface of the lower electrode and used for preventing the upper electrode from contacting the lower electrode to form short circuit between the upper electrode and the lower electrode when the upper electrode is attracted to come into contact with the surface of the optical waveguide.

### CROSS-REFERENCE TO RELATED APPLICATIONS

This is a continuation of International Application No. PCT/CN2023/078056, filed on Feb. 24, 2023, which claims priority to Chinese Patent Application No. 202210383343.5, filed on Apr. 12, 2022. All of the aforementioned applications are hereby incorporated by reference in their entireties.

### TECHNICAL FIELD

The present disclosure relates to the field of semiconductor electro-optical devices, and in particular, to an integrated optical coupling switch.

### BACKGROUND

An integrated optical coupling switch is a modulator made by utilizing an electro-optical effect of an electro-optical material, such as lithium niobate crystal (LiNbO₃) or lithium tantalate crystal (LiTaO₃). The electro-optical effect refers that a refractive index of the electro-optic material changes when a voltage is applied to a coupling area, causing the characteristics of the optical waves passing through this area to change. The integrated optical coupling switch can be utilized to modulate a phase, an amplitude, and a polarization state of an optical signal.

The integrated optical coupler, as a coupler utilizing the electro-optical effect to perform modulation, is composed of two optical waveguides which are parallel to each other and have a relatively same distance between them. Light from one optical waveguide can be coupled into the other one optical waveguide, and a function of a suitable electric field is to change the material characteristics of the optical waveguides, resulting in optical coupling between the two optical waveguides. Within one coupling length of the light, when there is no voltage applied to an electrode, light propagating within one optical waveguide is fully coupled to propagate into the other one optical waveguide; and when there is a voltage applied to an electrode, light that enters one optical waveguide, after coupling, will maintain propagation and output in an original optical waveguide.

In other words, the integrated optical coupling switch is to apply a bias voltage through the electrode to change the propagation characteristics of the optical waveguide. Therefore, the stability of the integrated optical coupling switch is affected by the applied bias voltage.

### SUMMARY

In order to solve the above problems, the present disclosure provides an integrated optical coupling switch, which ensures the stability of operation of the integrated optical coupling switch by improving the stability of electrode performance.

In order to solve the above technical problems, the integrated optical coupling switch provided in the present disclosure includes two optical waveguides parallel to each other; two optical waveguides parallel to each other; and an insulating layer. The two electrodes include a lower electrode that is arranged on a silicon surface and avoids the optical waveguides, and an upper electrode that is arranged above the optical waveguides and formed as a micro-electromechanical architecture, and the upper electrode is attracted to come into contact with surfaces of the optical waveguides when reaching a preset voltage value. The insulating layer is provided on a surface of the lower electrode and used for preventing the upper electrode from directly contacting the lower electrode to cause short circuit when the upper electrode is attracted to come into contact with the surfaces of the optical waveguides.

In an embodiment, the upper electrode is formed as the micro-electromechanical architecture above the insulating layer and is spaced apart from the insulating layer.

In an embodiment, the upper electrode is arranged above the insulating layer and spaced apart from the insulating layer, a sacrificial layer is provided on the insulating layer and the upper electrode is provided on the sacrificial layer; and the sacrificial layer is removed to form a spacer layer between the upper electrode and the insulating layer.

In an embodiment, a surface of the upper electrode away from the insulating layer is provided with a material capable of enhancing strength of the upper electrode.

In an embodiment, both the insulating layer and the lower electrode are spaced apart from the optical waveguides.

In an embodiment, the optical waveguides are formed by a material including silicon nitride or a transparent insulating substance with a high refractive index.

In an embodiment, both the insulating layer and the lower electrode are spaced apart from the optical waveguides.

In an embodiment, the integrated optical coupling switch further includes a silicon substrate, the lower electrode is provided on the silicon substrate.

In an embodiment, a projection area of the upper electrode onto the silicon substrate is equal to a projection area of the optical waveguide adjacent to the upper electrode onto the silicon substrate.

In an embodiment, a projection area of the upper electrode onto the silicon substrate is larger than a projection area of the optical waveguide adjacent to the upper electrode onto the silicon substrate and does not overlap with a projection area of the other optical waveguide onto the silicon substrate.

In an embodiment, the lower electrode and the upper electrode are formed by a material including aluminum alloy, silicon series material, or metal compatible with a silicon process.

In an embodiment, the optical waveguides are Mach Zehender optical waveguides.

With the above-described solutions, the integrated optical coupling switch in the present disclosure isolates the lower electrode from the upper electrode by means of the insulating layer. When the upper electrode of the integrated optical coupling switch is attracted downward toward the lower electrode to come into contact with the optical waveguides upon that a pre-set voltage value is applied to the upper electrode of the integrated optical coupling switch, the lower electrode and the upper electrode can still be kept apart from each other. In this way, there is no problem of short circuit caused by contact between the lower electrode and the upper electrode, thereby ensuring the stability of the performance of the integrated optical coupling switch during operation and improving the yield of the integrated optical coupling switch.

### BRIEF DESCRIPTION OF DRAWINGS

In order to better illustrate the technical solutions in the embodiments of the present disclosure, the drawings required to be used in the description in the embodiments will be briefly introduced below. Obviously, the drawings in the following description merely illustrate some of, rather than all of the embodiments of the present disclosure, and those skilled in the art can also obtain other drawings according to these drawings without creative work.

FIG. 1 is a perspective view of an integrated optical coupling switch in an embodiment of the present disclosure in a top-view state.

FIG. 2 is a cross-sectional view along A-A of the integrated optical coupling switch in FIG. 2 in a first state.

FIG. 3 is a cross-sectional view along A-A of the integrated optical coupling switch in FIG. 2 in a second state.

FIG. 4 is a cross-sectional view of an integrated optical coupling switch in an embodiment of the present disclosure during some manufacturing process.

### DESCRIPTION OF EMBODIMENTS

The technical solutions in the embodiments of the present disclosure will be described below with reference to the accompanying drawings. Obviously, the described embodiments are only some of, rather than all of the embodiments of the present disclosure. Based on the embodiments in the present disclosure, all other embodiments obtained by those of ordinary skill in the art without making creative efforts fall within a scope of the present disclosure.

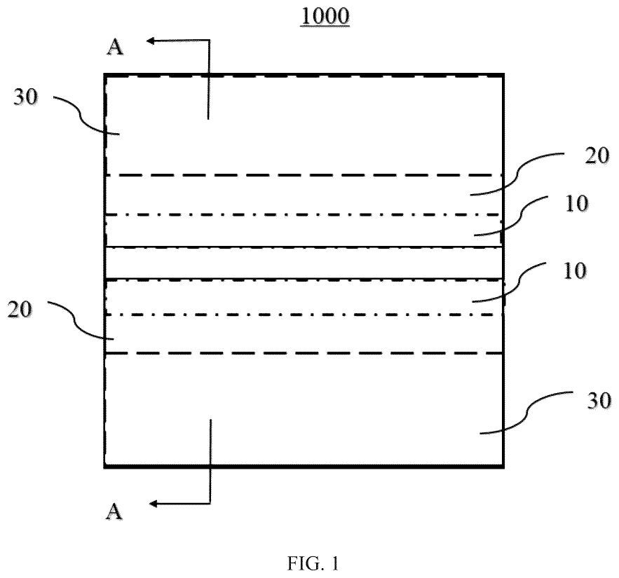

Please refer to FIG. 1, which is a perspective view of an integrated optical coupling switch in an embodiment of the present disclosure in a top-view state, the integrated optical coupling switch 1000 includes two optical waveguides 10 parallel to each other. In an embodiment, the optical waveguides 10 are Mach Zehender optical waveguides. The optical waveguides 10 may also be preset with a specific shape, such as ridge-shaped optical waveguides.

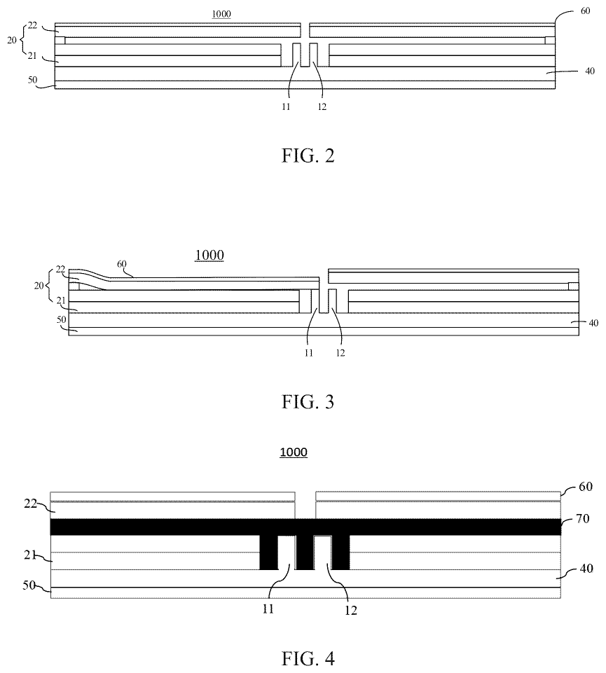

Please also refer to FIG. 2, which shows a cross-sectional view along line A-A of the integrated optical coupling switch 1000 in FIG. 1 in a first state, the integrated optical coupling switch 1000 further includes two electrode pairs 20 and an insulating layer 30. Each electrode pair 20 of the two electrode pairs 20 includes two electrostatically attracted electrodes, that is, a lower electrode 21 that is arranged on a silicon surface and avoids the optical waveguides 10, and an upper electrode 22 that is arranged above the optical waveguides 10 and formed as a micro-electromechanical architecture. The upper electrode 22 is attracted to come into contact with a surfaces of the optical waveguide 10 when reaching a preset voltage value; and the upper electrode 22 does not contact the optical waveguide 10 when the voltage value applied to the lower electrode 21 and the upper electrode 22 does not reach the preset voltage value. Not reaching the preset voltage value includes: the lower electrode 21 and the upper electrode 22 being not applied with a voltage; or, the applied voltage is less than the preset voltage value. In the embodiments of the present disclosure, the two electrode pairs 20 are provided outside the two parallel optical waveguides 10, and the insulating layer 30 is sandwiched in each electrode pair 20 for separating the lower electrode 21 from the upper electrode 22 of the electrode pair 20. In an example, the insulating layer 30 may be formed by one of nitrocellulose polymer, silicon nitride, or silicon dioxide, preferably silicon dioxide.

For ease of understanding, the two parallel optical waveguides 10 are defined as the first optical waveguide 11 and the second optical waveguide 12 in the following description. In an embodiment of the present disclosure, when there is no voltage on the electrode pairs 20, the light propagating in the first optical waveguide 11 in the integrated optical coupling switch 1000 is completely coupled to the second optical waveguide 12, and continues to propagate in the second optical waveguide 10, eventually resulting in no light being output from the first optical waveguide 11 and all of the light being coupled into the second optical waveguide 12 for output. When there is a voltage on the electrode pairs 20 and the value of the voltage reaches a preset value, the light entering the first optical waveguide 11 of the integrated optical coupling switch 1000 will completely return to the original first optical waveguide 11 for propagation and output after being coupled, and similarly, the light entering the second optical waveguide 12 will completely return to the original second optical waveguide 12 for propagation and output after being coupled. In this way, the integrated optical coupling switch 1000 can be switched between the above-mentioned two states by applying a preset voltage or applying no voltage to the electrode pairs 20.

Regarding the integrated optical coupling switch 1000, when there is no voltage applied to the electrode pairs 20 or the voltage applied to the electrode pairs 20 does not reach the preset voltage value, the light propagating in the first optical waveguide 11 is completely coupled to the second optical waveguide 12 and then continues to propagate, eventually resulting in no light output from the first optical waveguide 11, and all of the light is coupled to the second optical waveguide 12 for output. In an embodiment of the present disclosure, a state in which the integrated optical coupling switch 1000 is in this situation is defined as a first state, that is, the light propagating in the first optical waveguide 11 of the integrated optical coupling switch 1000 is completely coupled to the second optical waveguide 12 and then continues to propagate, eventually resulting in a state in which there is no light output from the original first optical waveguide 11 and all of the light is coupled to the second optical waveguide 12 for output.

Further, regarding the integrated optical coupling switch 1000, when the voltage applied to the electrode pairs 20 reaches the preset voltage value, the light entering the first optical waveguide 11 of the integrated optical coupling switch 1000 will completely return to the original first optical waveguide 11 to propagate and output after being coupled, and similarly, the light entering the second optical waveguide 12 will completely return to the original second optical waveguide 12 to propagate and output after being coupled. In an embodiment of the present disclosure, a state in which the integrated optical coupling switch 1000 is in this situation is defined as a second state, that is, the light in an optical waveguide of the integrated optical coupling switch 1000 will completely return to the original optical waveguide for propagation and output after being coupled.

In the embodiments, each electrode pair 20 of the two electrode pairs 20 includes a lower electrode 21 and an upper electrode 22 spaced apart from each other. The lower electrodes 21 are provided outside the optical waveguides 10. That is, one lower electrode 21 is provided outside one of the first optical waveguide 11 and the second optical waveguide 12, and the other one lower electrode 21 is provided outside the other one of the first optical waveguide 11 and the second optical waveguide 12. The insulating layer 30 is provided between the lower electrode 21 and the upper electrode 22. In an embodiment, the insulating layer 30 is provided on a surface of the lower electrode 21. The insulating layer 30 may be directly or indirectly provided on the surface of the lower electrode 21. For embodiment, the insulating layer 30 may be directly attached to the surface of the lower electrode 21 and directly contacts the lower electrode 21, or the insulating layer 30 may be provided at an interval over the surface of the lower electrode 21 and dose not directly contact the lower electrode 21. Further, the insulating layer 30 is located outside the optical waveguides 10. For example, two insulating layers 30 are provided outside the two the optical waveguides 10, that is, one insulating layer 30 is provided outside one of the first optical waveguide 11 and the second optical waveguide 12, and the other one insulating layer 30 is provided outside the other one of the first optical waveguide 11 and the second optical waveguide 12.

In this way, the lower electrode 21 and the upper electrode 22 are separated from each other by the insulating layer 30, which can avoid the problem of short circuit caused by contact between the lower electrode 21 and the upper electrode 22, thereby ensuring the stability of the performance of the integrated optical coupling switch 1000 during operation, and improving the product yield of the integrated optical coupling switch.

Further, the upper electrode 22 is spaced apart from the insulating layer 30 and is provided above the insulating layer 30. For example, the upper electrode 22 is formed above the insulating layer 30 in a micro-electromechanical architecture, and is spaced apart from the insulating layer 30. In this way, the upper electrode 22 and the lower electrode 21 can be further prevented from contacting each other, and the problem of short circuit between the upper electrode 22 and the lower electrode 21 can be prevented.

Please refer to FIG. 4, which shows a cross-sectional view when the upper electrode 22 is formed over the insulating layer 30 in an embodiment of the integrated optical coupling switch 1000. In this embodiment, a sacrificial layer 70 is first provided on the insulating layer 30, and then the upper electrode 22 is provided on the sacrificial layer 70; finally, the sacrificial layer 70 is etched away. In this way, a spacer layer can be formed between the upper electrode 22 and the insulating layer 30 to enable the upper electrode 22 to be spaced apart from the insulating layer 30 and provided above the insulating layer 30. A method for etching away the sacrificial layer 70 includes wet etching and dry etching. It should be understood that the spacer layer formed between the upper electrode 22 and the insulating layer 30 may be an air layer or an inert gas layer, which will not be limited herein. In an embodiment, the sacrificial layer 70 may be photoresist.

Further, after the sacrificial layer 70 is provided on the insulating layer 30, a surface of the sacrificial layer 70 away from the lower electrode 21 may be polished, for example, by chemical mechanical polishing. In this way, the flatness of the surface of the sacrifice layer 70 away from the lower electrode 21 can be ensured. Further, when the upper electrode 22 is provided on the polished sacrificial layer 70, the surface of the upper electrode 22 facing the insulating layer 30 is also flat after the sacrificial layer 70 is etched away. In this way, when the upper electrode 22 is attracted toward the lower electrode 21 to contact the optical waveguide 10 by an applied voltage, the contact between the upper electrode 22 and the optical waveguide 10 is more sufficient and flat, thereby reducing an influence on the performance of the integrated optical coupling switch 1000 caused by the contact flatness.

Please refer to FIG. 3, which shows a cross-sectional view along A-A of the integrated optical coupling switch 1000 in FIG. 1 in a second state. In this second state, the voltage difference applied to the lower electrode 21 and the upper electrode 22 reaches a preset voltage value, and the upper electrode 22 is attracted toward the lower electrode 21 under the action of the voltage difference to come into contact with the optical waveguide 10 (such as the first optical waveguide 11 shown in the figure). For example, when the optical waveguides 10 are ridge-shaped waveguides, the upper electrode 22 is attracted toward the lower electrode 21 under the action of the voltage difference to come into contact with a ridge-shaped top face of the ridge-shaped waveguide. In this embodiment, the upper electrode 22 can be attracted to come into contact with the first optical waveguide 11 or the second optical waveguide 12, which is at the same side as the upper electrode 22.

In an embodiment, the lower electrode 21 can be grounded, and the upper electrode 22 is used for receiving a driving voltage provided by an external circuit or other driving circuit. In this way, by adjusting the driving voltage received by the upper electrode 22, the integrated optical coupling switch 1000 can be switched between the first state and the second state.

Since the insulating layer 30 is provided between the lower electrode 21 and the upper electrode 22, when the integrated optical coupling switch 1000 is in the second state, the lower electrode 21 and the upper electrode 22 may be kept spaced apart from each other when the upper electrode 22 is attracted downward toward the lower electrode 21 to come into contact with the optical waveguides 10 when a preset voltage value is applied. In this way, there is no problem of short circuit caused by contact between the lower electrode 21 and the upper electrode 22, thereby ensuring the stability of the performance of the integrated optical coupling switch during operation and improving the yield of the integrated optical coupling switch.

Further, in an embodiment of the present disclosure, the lower electrode 21 and the upper electrode 22 are conductors, which can be made of gold, aluminum, tungsten, doped polysilicon and other materials, preferably aluminum alloy, silicon series materials, or metal compatible with a silicon process.

In the embodiments of the present disclosure, the insulating layer 30 and the lower electrode 20 both are spaced apart from the optical waveguides 10, that is, a spacing area is provided between the insulating layer 30 and the optical waveguide 10 and between the lower electrode 20 and the optical waveguide 10, so that neither the insulating layer 30 nor the lower electrode 20 is in contact with the optical waveguide 10 in the horizontal direction. As such, it can further reduce the possibility of contact between the lower electrode 21 and the upper electrode 22 when the upper electrode 22 is attracted downward toward the lower electrode 21 to come into contact with the optical waveguides 10 under an action of a voltage difference. In this way, the possibility of contact between the lower electrode 21 and the upper electrode 22 when the upper electrode 22 is attracted downward toward the lower electrode 21 to come into contact with the optical waveguides 10 under an action of a voltage difference can be further reduced.

In an embodiment, a material 60 capable of enhancing the strength of the upper electrode 22 is provided on an upper surface of the upper electrode 22 away from the insulating layer 30. The material 60 is used for enhancing the stress and strength of the upper electrode 22, so that the upper electrode 22 can better recover to the state before being attracted downward towards the lower electrode 21 upon the applied voltage is withdrawn, and thus further improving and ensuring the product performance and yield of the integrated optical coupling switch 1000. In an example, the material 60 may be made of a metal or dielectric layer with higher hardness.

In the embodiments, the insulating layer 30 and the optical waveguides 10 are positioned at a same level. In other embodiments, a horizontal height at which the insulating layer 30 is located is higher than a horizontal height at which the optical waveguide 10 is located. It should be noted that the horizontal height referred to herein means that the insulating layer 30 and the optical waveguide 10 each extend downwardly from a top face thereof to a bottom face of the lower electrode 21, and the bottom face of the lower electrode 21 is a surface of the lower electrode 21 that is directly opposite to the insulating layer 30 and away from the insulating layer 30.

In an embodiment, the integrated optical coupling switch 1000 further includes a silicon substrate layer 40. The lower electrodes 21 and the optical waveguides 10 are all directly or indirectly provided on the silicon substrate layer 40.

In an embodiment, the integrated optical coupling switch 1000 further includes a base layer 50. The silicon substrate layer 40 is provided on the base layer 50. In an example, the base layer 50 is a silicon base layer.

In an embodiment, a projection area of the upper electrode 22 onto the substrate layer 40 is equal to a projection area of the optical waveguide 10 adjacent to the upper electrode 22 onto the silicon substrate layer 40. In another embodiment, a projection area of the upper electrode 22 onto the silicon substrate layer 40 is larger than a projection area of the optical waveguide 10 (for embodiment, the first optical waveguide 11) adjacent to the upper electrode 22 onto the silicon substrate layer 40, and does not overlap with a projection area of the other optical waveguide 10 (for embodiment, the second optical waveguide 12) onto the silicon substrate layer 40. In the case that the projection area of the upper electrode 22 onto the silicon substrate layer 40 is larger than the projection area of the optical waveguide 10 adjacent to the upper electrode 22 onto the silicon substrate layer 40, when the upper electrode 22 is attracted towards the lower electrode 21 to come into contact with the optical waveguides 10 upon that a predetermined voltage value is applied, the upper electrode 22 can be brought into contact with the upper surface of the optical waveguide 10 more completely fit, that is, it can ensure that the upper surface of the optical waveguide 10 is totally covered by the upper electrode 22 in full contact.

It is known to those skilled in the art that when the upper electrode 22 and the upper surface of the optical waveguide 10 have larger fitting areas, the integrated optical coupling switch 1000 has better performance and is more stable.

In an embodiment, the material of the optical waveguides 10 is silicon nitride or a transparent insulating substance with a high refractive index. The transparent insulating substance may be silicide.

The above description merely illustrates some embodiments of the present disclosure, and does not limit the present disclosure. Any equivalent structure or equivalent process transformation using the contents of the description and the accompanying drawings of the present disclosure, or direct or indirect apply of the contents in other relevant technical fields, are all similarly included in the patent protection scope of the present disclosure.

What is claimed is:

1. An integrated optical coupling switch, comprising:
two optical waveguides parallel to each other;
two electrodes that are electrostatically attracted to each other, wherein the two electrodes comprise a lower electrode that is arranged on a silicon surface and avoids the optical waveguides, and an upper electrode that is arranged above the optical waveguides and formed as a micro-electromechanical architecture, and the upper electrode is attracted to come into contact with surfaces of the optical waveguides when reaching a preset voltage value; and
an insulating layer provided on a surface of the lower electrode and used for preventing the upper electrode from directly contacting the lower electrode to cause short circuit when the upper electrode is attracted to come into contact with the surfaces of the optical waveguides.

2. The integrated optical coupling switch according to claim 1, wherein the upper electrode is provided as a micro-electromechanical architecture above the insulating layer and is spaced apart from the insulating layer.

3. The integrated optical coupling switch according to claim 1, wherein the upper electrode is arranged above the insulating layer and spaced apart from the insulating layer, and a spacer layer is provided between the upper electrode and the insulating layer.

4. The integrated optical coupling switch according to claim 3, wherein the spacer layer may be an air layer or an inert gas layer.

5. The integrated optical coupling switch according to claim 3, wherein both the insulating layer and the lower electrode are spaced apart from the optical waveguides.

6. The integrated optical coupling switch according to claim 1, wherein the lower electrode and the upper electrode are separated from each other by the insulating layer.

7. The integrated optical coupling switch according to claim 6, wherein the lower and upper electrodes are provided outside the two parallel optical waveguides, and the insulating layer is sandwiched in lower and upper electrodes electrode for separating the lower electrode from the upper electrode of the electrode.

8. The integrated optical coupling switch according to claim 1, wherein the insulating layer may be formed by one of nitrocellulose polymer, silicon nitride, or silicon dioxide.

9. The integrated optical coupling switch according to claim 1, wherein a surface of the upper electrode away from the insulating layer is provided with a material capable of enhancing strength of the upper electrode.

10. The integrated optical coupling switch according to claim 9, wherein the material may be made of a metal or dielectric layer with higher hardness.

11. The integrated optical coupling switch according to claim 1, wherein the optical waveguides are formed by a material comprising silicon nitride or a transparent insulating substance with a high refractive index.

12. The integrated optical coupling switch according to claim 1, further comprising a silicon substrate, wherein the lower electrode is provided on the silicon substrate.

13. The integrated optical coupling switch according to claim 12, wherein a projection area of the upper electrode onto the silicon substrate is equal to a projection area of the optical waveguide adjacent to the upper electrode onto the silicon substrate.

14. The integrated optical coupling switch according to claim 13, wherein a projection area of the upper electrode onto the silicon substrate is larger than a projection area of the optical waveguide adjacent to the upper electrode onto the silicon substrate and does not overlap with a projection area of the other optical waveguide onto the silicon substrate.

15. The integrated optical coupling switch according to claim 1, wherein the insulating layer and the optical waveguides are positioned at a same level or the insulating layer is located is higher than a horizontal height at which the optical waveguide is located.

16. The integrated optical coupling switch according to claim 3, wherein the sacrificial layer may be photoresist.

17. The integrated optical coupling switch according to claim 13, wherein the lower electrode and the upper electrode are formed by a material comprising aluminum alloy, silicon series material, or metal compatible with a silicon process.

18. The integrated optical coupling switch according to claim 1, wherein the optical waveguides are Mach Zehender optical waveguides.

19. A method for forming an integrated optical coupling switch,
wherein the integrated optical coupling switch comprises:
two optical waveguides parallel to each other;
two electrodes that are electrostatically attracted to each other, wherein the two electrodes comprise a lower electrode that is arranged on a silicon surface and avoids the optical waveguides, and an upper electrode that is arranged above the optical waveguides and formed as a micro-electromechanical architecture, and the upper electrode is attracted to come into contact with surfaces of the optical waveguides when reaching a preset voltage value; and
an insulating layer provided on a surface of the lower electrode and used for preventing the upper electrode from directly contacting the lower electrode to cause short circuit when the upper electrode is attracted to come into contact with the surfaces of the optical waveguides, and
wherein the method comprises:
forming a sacrificial layer on the insulating layer;
providing the upper electrode onto the sacrificial layer;
etching the sacrificial layer away to form a spacer layer between the upper electrode and the insulating layer.

20. The method for forming the integrated optical coupling switch according to claim 19,
wherein the method further comprises:
polishing a surface of the sacrificial layer away from the lower electrode, to make the surface of the sacrificial layer away from the lower electrode flat.
